(19) United States
(12) Patent Application Publication
(10) Pub. No.: US 2024/0202697 A1
(43) Pub. Date: Jun. 20, 2024

(54) PAYMENT SOLUTION, ESPECIALLY DIGITAL PAYMENT SOLUTION

(71) Applicant: GIESECKE+DEVRIENT EPAYMENTS GMBH, Munchen (DE)

(72) Inventor: Ranjan GHOSH, Bengaluru (IN)

(21) Appl. No.: 18/556,820

(22) PCT Filed: Apr. 25, 2022
(86) PCT No.: PCT/EP2022/025178

§ 371 Date: Oct. 23, 2023

(30) Foreign Application Priority Data
Apr. 26, 2021 (DE) 10 2021 002 193.2

(51) Int. Cl. G06Q 20/32; G06Q 20/34; H04W 8/20; H04W 12/30

(52) U.S. Cl. CPC G06Q 20/3229; G06Q 20/355; H04W 8/205; H04W 12/35

(57) ABSTRACT

A payment solution provisioning system includes a payment card credential transfer interface means between a payment card production system and a remote SIM provisioning system, and by a payment card credential storage at the remote SIM provisioning system, storing payment card credentials received at the remote SIM provisioning system from the payment card production system, storing such that the payment card credentials can be downloaded to an eUICC the way normally subscription profiles are downloaded to a eUICC. The payment card credentials stored in the eUICC are a digital payment solution. The same payment card credentials personalized into a physical payment card at the payment card production system are a physical payment solution. Both together build a combined digital and physical payment solution. A mobile device comprises a payment application.

### FIELD OF THE INVENTION

The present invention relates to the field of payment solutions, especially digital payment solutions such as digital payment cards implemented in mobile devices.

### BACKGROUND OF THE INVENTION

Physical payment cards including a payment chip are in the market for a long time, and payment cards using a magnetic stripe even longer. Physical payment cards are produced in a card manufacturer card production infrastructure by personalization of the cards with personalization data received from a card issuer, such as a bank or a payment scheme provider, and further card production data.

The personalization data can comprise for example one or several of the following: (i) personal data—such as name—of a future holder of the payment card, i.e. client of the card issuer, (ii) payment card credentials, such as a card number—e.g. the primary account number PAN—, secret keys for authentication of payment transactions to be effected with the payment card once the card is issued to the card holder, and (iii) payment applications or applets. Some of the personalization data such as card holder name, PAN and the mandatory keys are mandatory, others are optional. Card production data can comprise data for chip personalization, for card body printing and embossing and for magnetic stripe programming. The personalized payment cards are each enveloped together with a client letter and sent to the respective card holder, i.e. card issuer client, via postal services. In a separate PIN letter, the payment card PIN code is sent to the card holder. From the time a card issuer client orders a payment card at the card issuer until the time the card issuer client actually receives the payment card and the PIN letter, a considerable amount of time can pass.

Digital payment solutions, such as digital payment cards, for example payment applets making use of payment card credentials, implemented in mobile devices are gaining increasing importance. A mobile device is understood as a device having functionality to communicate in a mobile or radio communication network, such as a Smartphone or Smartwatch which are also classified as Consumer devices, or an M2M mobile network device. Current digital payment solutions usually exist in addition to and separately from physical payment cards.

### Prior Art

US2016088464A1 of the prior art discloses an eUICC storing a plurality of profiles, wherein each profile represents a subscriber identity module for a mobile network operator, and applications, each associated with one of the plurality of profiles.

WO2017201908A1 of the prior art discloses a method of loading and storing, to a security domain of an eUICC, a key application program associated with a bank card and key data. The key data can comprise an encryption and decryption key, a signing key or a password. For loading to the security domain of the eUICC and authentication, a GSMA SM-SR is used.

GSMA Technical Specification SGP.02 V4.1—GSMA SGP.02 Remote Provisioning Architecture for Embedded UICC Technical Specification, Version 4.1, 05 Jun. 2020 —discloses in chapter 3.1 a method for profile downloads and installation to an eUICC, including a mutual authentication procedure according to chapter 3.1.2, and a download and installation procedure according to chapter 3.1.3, and is intended for eUICCs hosted in M2M mobile devices.

GSMA Technical Specification SGP.22 V2.2.2, chapter 3.1 Remote Provisioning—GSMA SGP.22 RSP Technical Specification, Version 2.2.2, 05 Jun. 2020—discloses in chapter 3.1 a method for profile downloads and installation to an eUICC, including a mutual authentication procedure according to chapter 3.1.2, and a download and installation procedure according to chapter 3.1.3, and is intended for eUICCs hosted in consumer mobile devices, such as Smartphones or Smartwatches.

### Objective of the Invention

It is an object of the present invention to provide a provisioning solution that allows to provision a payment solution to a user in a fast, flexible and user-friendly way.

### Summary of the Invention

The payment solution provisioning system is characterized by a payment card credential transfer interface means between a payment card production system and a remote SIM provisioning system, and by a payment card credential storage at the remote SIM provisioning system, storing payment card credentials received at the remote SIM provisioning system from the payment card production system, storing such that the payment card credentials can be downloaded to an eUICC the way normally subscription profiles are downloaded to an eUICC. The payment card credentials stored and/or implemented in the eUICC are a digital payment solution. The same payment card credentials personalized into a physical payment card at the payment card production system are a physical payment solution in form of a physical payment card. Both together build a combined digital and physical payment solution.

The payment solution provisioning system has several advantages. First, payment card credentials can be used identically in a physical payment card and in a digital payment card established in the eUICC by downloading the payment card credentials to the eUICC, and in parallel producing a physical payment card with the same payment card credentials. Second, the card holder for which the payment card credentials are destined can receive the digital payment solution/digital payment card established by the payment card credentials in the eUICC in a very fast manner, even before the physical payment card is received, and possibly even before the physical payment card is even produced. Third, the remote SIM provisioning infrastructures for downloading subscription profiles, such as according to SGP.02 or SGP.22, are well elaborated and accepted in the market. Therefore, the download of payment card credentials to the eUICC can be effected without requiring an own download infrastructure, however can benefit of procedures, particularly authentication, download and installation procedures, of remote SIM provisioning, for example as described in SGP.02 or SGP.22. Fourth, when the user desires to receive payment card credentials to an eUICC, so as to establish a digital payment solution in the eUICC, the user can use the established user-friendly ways offered for subscription profile download for example in SGP.02 or SGP.22, particularly for a consumer device for example one of the three ways of chapter 3.1.3, option (a) (Activation Code), (b) (SM-DS) or (c) (Default SM-DP+).

A mobile device according to the present invention hosts an eUICC. According to the invention, the mobile device comprises a payment application comprising a payment card credential interface which is constructed to send to a SIM provisioning system, via an RSP infrastructure, a payment card credential download request, and to manage receipt of requested payment card credentials from the SIM provisioning system, via the RSP infrastructure, and to store the received payment card credentials to the eUICC. The user can, by the inventive payment application, download payment card credentials in a similar way that allows today already to download subscription profiles to eUICCs.

Thus, the invention provides a provisioning solution that allows to provision a payment solution to a user in a fast, flexible and user-friendly way.

Preferably, the RSP infrastructure comprises payment card credential download means constructed to receive payment card credential download requests, and in reply to a received payment card credential download request, to download payment card credentials corresponding to the payment card credential download request to a eUICC. Preferably the payment card download request includes an identifier that assures that the correct payment card credentials are downloaded to the eUICC for which the user requested a physical payment card. The RSP infrastructure comprises a physical link—which can be wireless or wired—operable between the SIM provisioning infrastructure (e.g. SM-DP+ or SM-SR) and eUICC allowing download of profiles and payment card credentials.

Preferably, the payment card credential storage is provided incorporated in a data generation system provided in the Data Preparation server or Data Preparation Plus server. In relation to subscription profiles, the data generation system processes profile data such as the authentication key Ki and the international mobile subscriber identifier IMSI with a profile description so as to generate a profile package which can be downloaded to an eUICC.

Preferably, the data generation system is constructed to process payment card credentials stored in the payment card credential storage together with a payment card description, so as to generate a payment card package which can be downloaded to the eUICC, so as to install in the eUICC a digital payment solution, particularly a digital payment card. The payment card description is preferably structured similarly to a profile description, such that the data generation system can create a package for a digital payment solution, particularly a digital payment card, to be installed in the eUICC, similarly as the known data generation system generates a profile package by which a subscription profile can be installed in the eUICC. Details of profile package generation are described in SGP.02 or SGP.22 or in in documents referenced in SGP.02 or SGP.22.

Preferably, the payment card credentials stored on the payment card credential storage and downloaded to the eUICC are accompanied by a payment card applet also stored on the payment card credential storage and downloaded and installed to the eUICC such that the payment card applet makes use of the payment card credentials in payment transactions. Preferably, the payment card credentials stored in the eUICC are identical to payment card credentials used to produce a physical payment card.

Preferably, the received payment card credentials are stored in the eUICC in such a way that the payment card credentials stored in the eUICC can be used for payments in a similar way to a payment card produced from the payment card credentials. Preferably also a payment card applet is stored to the eUICC, and the payment card credentials are used by the payment card applet. The payment card applet together with the payment card credentials preferably build a digital payment solution or digital payment card.

The eUICC to which the payment card credentials are installed can have any form factor, for example plug-in SIM card, embedded eUICC which is made for soldering into a mobile device and otherwise partly similar to a plug-in SIM card, or integrated iUICC integrated into a chipset of the mobile device.

### BRIEF DESCRIPTION OF THE DRAWINGS

Embodiments of the invention will now be described with reference to the drawings, throughout which like parts are referred to by like references, and in which represents:

FIG. 1 a schematic diagram of a payment solution provisioning system, according to an embodiment of the invention;

FIG. 2 a chart showing providing of payment card credentials from a payment card production system to a SIM provisioning system via a payment card credential transfer interface, followed by a mobile device requesting download of the payment card credentials to an eUICC and finally download of the payment card credentials to the eUICC, according to an embodiment of the invention;

FIG. 3 a mobile device hosting an eUICC and comprising a payment application comprising a payment card credential interface, according to an embodiment of the invention.

### DETAILED DESCRIPTION OF THE INVENTION

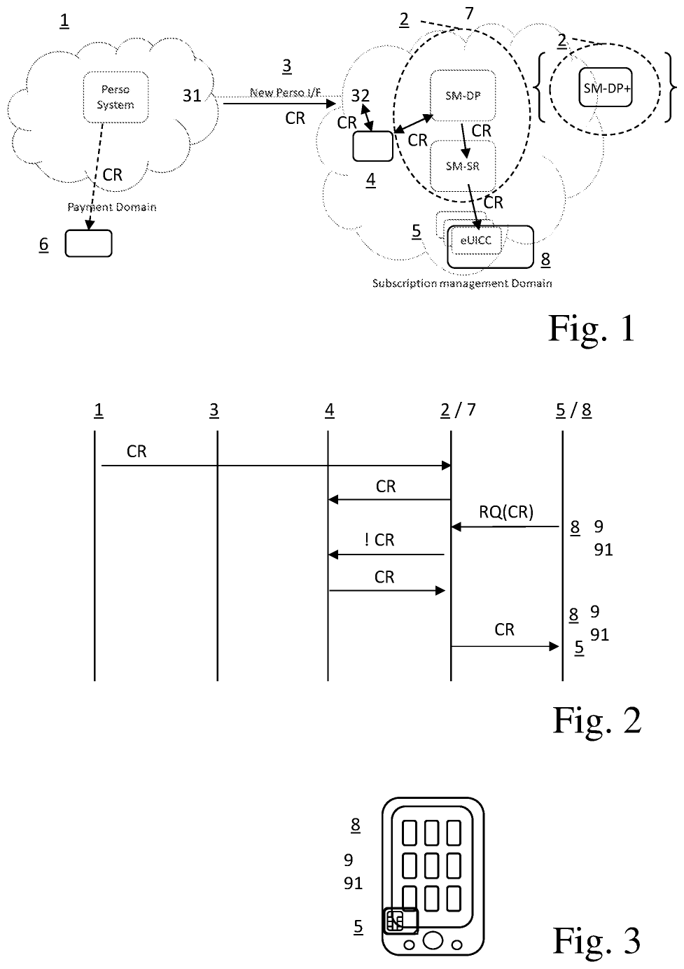

FIG. 1 shows a schematic diagram of a payment solution provisioning system, according to an embodiment of the invention. The payment solution provisioning system comprises a payment card production system 1 comprising at least a payment card personalization server constructed to personalize physical payment cards, like the payment card 6 shown in FIG. 1.

The payment solution provisioning system further comprises a remote SIM provisioning system 2 comprising an RSP infrastructure 7 constructed to provide subscription profiles to eUICCs 5. The SIM provisioning system 2 comprises at least: either (i) a subscription management Data Preparation server SM-DP and a subscription management Secure Router server SM-SR. for example according to GSMA SGP.02, or alternatively a subscription management Data Preparation Plus server SM-DP+, for example according to GSMA SGP.22. The subscription management Data Preparation Plus server SM-DP+ preferably essentially combines both functionalities of a subscription management Data Preparation server and a subscription management Secure Router server in one server system.

The payment solution provisioning system is characterized by a payment card credential transfer interface means 3 between the payment card production system 1 and the remote SIM provisioning system 2, and by a payment card credential storage 4.

The interface means 3 comprises a payment card production side interface section 31 constructed to provide payment card credentials CR, provided in the payment card production system 1 for production of a physical payment card 6, to the remote SIM provisioning system 2. The interface means 3 further comprises a remote SIM provisioning system side interface section 32 constructed to receive payment card credentials CR provided by a payment card production system 1 at the payment card production side interface 31.

The payment card credential storage 4 is provided in the or connected to the or connectable to the remote SIM provisioning system 2, and is constructed to store the payment card credentials CR, which are or have been received via the payment card credential transfer interface means 3. The payment card credential storage 4 stores the payment card credentials CR in such a way that the payment card credentials CR can be provided to eUICCs 5 via the RSP infrastructure 7 of the remote SIM provisioning system 2 via which subscription profiles are provided to eUICCs 5.

FIG. 2 shows a chart showing providing of payment card credentials CR from a payment card production system 1 to a SIM provisioning system 2 via a payment card credential transfer interface 3, followed by a mobile device 8 requesting download of the payment card credentials CR to an eUICC 5, and finally download of the payment card credentials CR to the eUICC 5, according to an embodiment of the invention.

FIG. 3 shows a mobile device 8, embodied as a Smartphone, with an eUICC 5 hosted in the mobile device 8. The eUICC is depicted as a plug-in SIM card. The mobile device 8 comprises a payment application 9 comprising a payment card credential interface 91. The payment application 9 with its payment card credential interface 91 is constructed to send to a SIM provisioning system 2, via an RSP infrastructure 7, a payment card credential download request RQ(CR). The RSP infrastructure 7 receives the payment card credential download request RQ(CR) and feeds it into the SIM provisioning system 2. The SIM provisioning system 2 analyses the request RQ(CR) and retrieves from the payment card credential storage 4 payment card credentials CR matching with the payment card credential download request RQ(CR), provides the retrieved payment card credentials CR on the SM-DP+ or SM-SR or similar server for download to the eUICC 5, and downloads the payment card credentials CR from the SM-DP+ or SM-SR or similar server to the eUICC 5 via the mobile device 8. At the mobile device 8, the payment application 9 with its payment card credential interface 91 receives and manages the requested payment card credentials CR from the SIM provisioning system 2 and initiates storage and installation of the received payment card credentials CR to the eUICC 5.

1.-10. (canceled)

11. A payment solution provisioning system comprising:
1) a payment card production system comprising at least:
a payment card personalization server constructed to personalize physical payment cards;
2) a remote SIM provisioning system comprising an RSP infrastructure constructed to provide subscription profiles to eUICCs, and comprising at least:
a subscription management Data Preparation server and a subscription management Secure Router server, or alternatively a subscription management Data Preparation Plus server and a link connectable to eUICCs;
wherein
3) a payment card credential transfer interface means comprising:
3.1) a payment card production side interface section constructed to provide payment card credentials, provided in the payment card production system for production of a physical payment card, to the remote SIM provisioning system; and
3.2) a remote SIM provisioning system side interface section constructed to receive payment card credentials provided by a payment card production system at the payment card production side interface; and
4) a payment card credential storage, provided in the or connected to the or connectable to the remote SIM provisioning system, the payment card credential storage constructed to store the payment card credentials, received via the payment card credential transfer interface means, in a way that the payment card credentials can be provided to eUICCs via the RSP infrastructure of the remote SIM provisioning system via which subscription profiles are provided to eUICCs.

12. The payment solution provisioning system according to claim 11, wherein the RSP infrastructure comprises profile download means constructed to receive and process profile download requests, and in reply to a received profile download request, to download a subscription profile to a eUICC corresponding to the profile download request,
wherein the RSP infrastructure comprises payment card credential download means constructed to receive payment card credential download requests, and in reply to a received payment card credential download request, to download payment card credentials corresponding to the payment card credential download request to a eUICC.

13. The payment solution provisioning system according to claim 11, wherein the payment card credentials stored on the payment card credential storage and downloaded to the eUICC are accompanied by a payment card applet also stored on the payment card credential storage and downloaded and installed to the eUICC such that the payment card applet makes use of the payment card credentials in payment transactions.

14. The payment solution provisioning system according to claim 11, wherein the payment card credentials stored in the eUICC are identical to payment card credentials used to produce a physical payment card.

15. The payment solution provisioning system according to claim 11, wherein the payment card credential storage is provided integrally with a data generation system provided in the Data Preparation server or Data Preparation Plus server.

16. The payment solution provisioning system according to claim 15, wherein the data generation system is constructed to process payment card credentials stored in the payment card credential storage together with a payment card description, so as to generate a payment card package which can be downloaded to the eUICC, so as to install in the eUICC a digital payment solution or digital payment card.

17. A mobile device hosting an eUICC, the mobile device comprising a payment application comprising a payment card credential interface constructed to send to a SIM provisioning system, via an RSP infrastructure, a payment card credential download request, and to manage receipt of requested payment card credentials from the SIM provisioning system, via the RSP infrastructure, and to store and/or install the received payment card credentials to the eUICC.

18. The mobile device hosting an eUICC according to claim 17, wherein the received payment card credentials are stored and/or installed in the eUICC in such a way that the payment card credentials stored and/or installed in the eUICC can be used for payments in a similar way to a payment card produced from the payment card credentials.

19. The mobile device hosting an eUICC according to claim 17, wherein the payment card credentials stored and/or installed in the eUICC are identical to payment card credentials used to produce a physical payment card.

20. The payment solution provisioning system according to claim 11, further comprising a mobile device hosting an eUICC, the mobile device comprising a payment application comprising a payment card credential interface constructed to send to a SIM provisioning system, via an RSP infrastructure, a payment card credential download request. and to manage receipt of requested payment card credentials from the SIM provisioning system, via the RSP infrastructure, and to store and/or install the received payment card credentials to the eUICC.
